(19) United States
(12) Patent Application Publication
(10) Pub. No.: US 2008/0277851 A1
(43) Pub. Date: Nov. 13, 2008

(54) Rolled medium supporting device for supporting both ends of rolled medium and recording apparatus having the rolled medium supporting device

(75) Inventor: Shin GENTA, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/692,042

(22) Filed: Mar. 27, 2007

(30) Foreign Application Priority Data
Mar. 28, 2006 (JP) 2006-089241
Mar. 28, 2006 (JP) 2006-089242

(51) Int. Cl. B23Q 1/64

(52) U.S. Cl. 269/56

(57) ABSTRACT

A roll-like medium supporting device includes flange members 117 that are fitted to both ends of the roll-like medium; a first holder member 113 that is fixed to a main body of the device so as to support one of the flange members; and a second holder member 114 that is disposed in the main body of the device to be movable in the axial direction of the roll-like medium so as to support the other flange member. With such a configuration, it is possible to eliminate necessity of a conventional lengthy roll shaft and thus to set the roll paper in a simple manner.

### BACKGROUND OF THE INVENTION

The present invention relates to a roll-like medium supporting device for supporting both ends of a roll-like medium and a recording apparatus having the roll-like medium supporting device. More specifically, the invention relates to a roll-like medium supporting device and a recording apparatus having the roll-like medium supporting device, in which the roll-like medium can be set in a simple manner with high precision.

Among printers, which are recording apparatuses, there is one which is provided with a function of recording data on paper rolled into a roll. In such a printer, roll paper supported by a roll shaft is set in a roll paper holder, the roll paper is pulled out by means of a paper feeding roller while being transported, and data is recorded on the roll paper by means of a recording head (see JP-A-2005-96987).

In the printer described above, it is necessary to insert the roll shaft through a core of the roll paper. When the width of the roll paper used is large, the axial length of the roll shaft should be increased to correspond to the width. Therefore, a large work space is required. In some cases, the work may require a lot of effort and thus deteriorates the setting properties. When the width of the roll paper is relatively smaller than the axial length of the roll shaft, the roll shaft tends to bend due to the maldistribution of loads in a state that the roll paper is set therein. This may cause deformation of the roll paper.

### DISCLOSURE OF INVENTION

The invention has been made in view of the above-described problems, and its object is to provide a roll-like medium supporting device and a recording apparatus having the roll-like medium supporting device, in which the roll-like medium can be set in a simple manner with high precision.

In order to accomplish the above-mentioned object, according to the invention, there is provided a roll-like medium supporting device which supports both ends of a roll-like medium. The roll-like medium supporting device includes flange members that are fitted to both ends of the roll-like medium; a first holder member that is fixed to a main body of the device so as to support one of the flange members; and a second holder member that is disposed in the main body of the device to be movable in the axial direction of the roll-like medium so as to support the other flange member. With such a configuration, it is possible to eliminate necessity of a conventional lengthy roll shaft and thus to set the roll paper in a simple manner.

The roll-like medium supporting device may be further provided with a guide member that guides the movement of the second holder member. With such a configuration, it is possible to handle roll papers with different widths in a simple manner.

The second holder member may be provided with a flange guide portion that guides the other flange member when the other flange member fitted to the roll-like medium is supported by the second holder member. With such a configuration, it is possible to fit the flange member to the second holder member in a simple manner.

The flange guide portion may be provided with a taper face for causing the flange member to slip thereon. With such a configuration, it is possible to fit the flange member to the second holder member at the same time with the movement of the second holder member.

The outer diameter of each of the flange members guide portion may be greater than the outer diameter of the roll-like medium. With such a configuration, the user can set the roll-like medium in the roll-like medium supporting apparatus with the roll-like medium held up with the user's hands.

The flange members and the second holder member may be provided with a rotation regulating portion that regulates the rotation of the roll-like medium when the roll-like medium is supported by the device. With such a configuration, it is possible to prevent unrolling of the roll-like medium after the roll-like medium is set.

In order to accomplish the above-mentioned object, according to the invention, there is provided a recording apparatus which records data on a roll-like recording medium while transporting the roll-like recording medium, in which the apparatus is provided with the above-described roll-like medium supporting device. With such a configuration, it is possible to provide a recording apparatus having the above-described advantages.

In order to accomplish the above-mentioned object, according to the invention, there is provided a roll-like medium supporting device which supports both ends of a roll-like medium. The roll-like medium supporting device includes flange members that are fitted to both ends of the roll-like medium; a first holder member that is fixed to a main body of the device so as to support one of the flange members; a second holder member that is disposed in the main body of the device to be movable in the axial direction of the roll-like medium so as to support the other flange member; and a guide member that guides the movement of the second holder member, wherein the second holder member is provided with a movable guide portion that makes sliding contact with the main body of the device and guides the movement of the second holder member. With such a configuration, it is possible to eliminate necessity of a conventional lengthy roll shaft and thus to set the roll paper in a simple manner. The second holder member can be supported in a distributed manner that the second holder member is supported by the main body of the device being in contact with the movable guide portion as well as by the guide member. Accordingly, it is possible to set the roll-like medium with high precision.

The movable guide portion may include a movable guide protrusion or a movable guide groove, which is formed to correspond to a holder guide groove or a holder guide protrusion formed in the main body of the device. With such a configuration, the movable guide portion can be moved smoothly with high precision.

The second holder member may be positioned at a predetermined position corresponding to the width of the roll-like medium. With such a configuration, it is possible to support different-sized roll-like mediums in a secure manner.

The second holder member may have a lock mechanism that locks the second holder member at the guide member. With such a configuration, it is possible to prevent oscillation of the roll-like medium supported therein.

In order to accomplish the above-mentioned object, according to the invention, there is provided a recording apparatus which records data on a roll-like recording medium while transporting the roll-like recording medium, in which the apparatus is provided with the above-described roll-like medium supporting device. With such a configuration, it is possible to provide a recording apparatus having the above-described advantages.

### BRIEF DESCRIPTION OF THE DRAWINGS

FIG. 1 is a perspective view of an ink-jet printer as an example of a recording apparatus, showing an exemplary construction according to an embodiment of the invention.

FIG. 2 is a perspective view of the ink-jet printer, showing the internal construction of a main part of the printer shown in FIG. 1.

FIG. 3 is a perspective view of a roll-like medium supporting device according to an embodiment of the invention.

FIG. 4 is a detailed perspective view of a movable flange receiver of the roll-like medium supporting device shown in FIG. 3.

FIGS. 5(A) and 5(B) are front and side views of the movable flange receiver shown in FIG. 4.

FIG. 6 is a detailed diagram showing the construction of a support shaft of the movable flange receiver and a flange support bearing.

FIG. 7 is a side sectional view of the movable flange receiver of a paper feeding unit and a peripheral portion thereof.

FIG. 8 is a first side view of the movable flange receiver and the peripheral portion thereof.

FIG. 9 is a second side view of the movable flange receiver and the peripheral portion thereof.

FIG. 10 is a first diagram for explaining an operation of setting a roll paper in a roll paper holder.

FIG. 11 is a second diagram for explaining the operation of setting the roll paper in the roll paper holder.

### DESCRIPTION OF THE PREFERRED EMBODIMENTS

Hereinafter, the invention will be described with reference to the accompanying drawings, in which preferred embodiments of the invention are shown. However, the invention should not be construed as being limited to the embodiments set forth herein. Moreover, the entire combinations of the features disclosed in the embodiments should not be construed as being essential to the means for solving the invention.

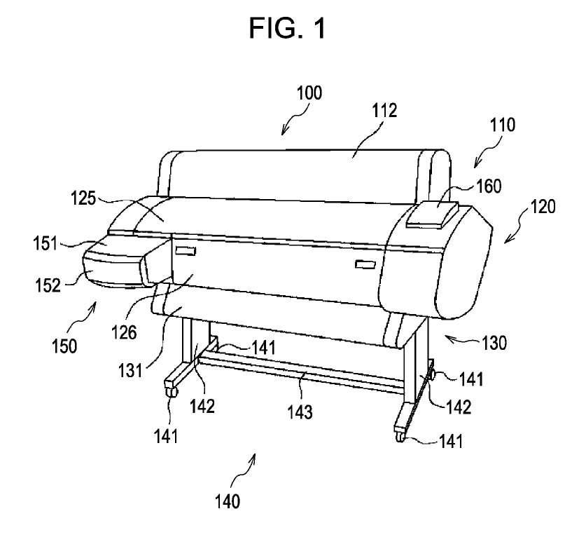

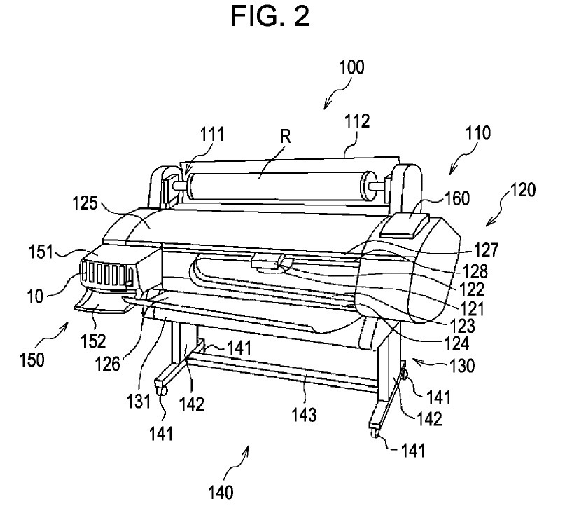

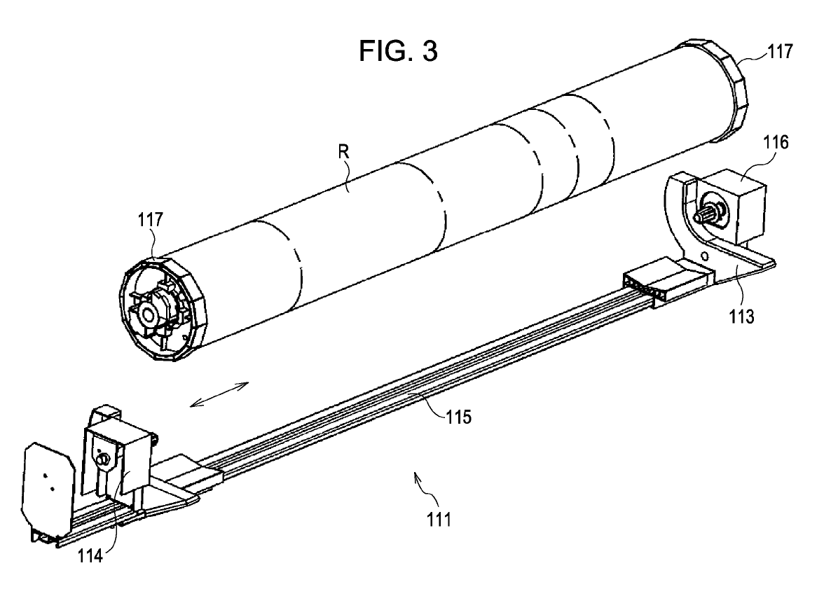

In the drawings, FIG. 1 is a perspective view of an ink-jet printer as an example of a recording apparatus, showing its exemplary construction according to an embodiment of the invention; FIG. 2 is a perspective view of the ink-jet printer, showing the internal construction of its main part; and FIG. 3 is a perspective view of a roll-like medium supporting device according to an embodiment of the invention. The ink-jet printer 100 is a large-sized printer capable of recording data on relatively large-format roll paper (roll-like medium), for example, a piece of paper of A1 size or B1 size in the JIS standard.

As shown in FIG. 1, in the ink-jet printer 100, a feeding unit 110 to which the roll paper is set, a recording/transporting unit 120, a paper discharging unit 130 and a leg portion 140 are arranged in this order from the upper portion thereof. Specifically, the roll paper supplied from the feeding unit 110 disposed in the uppermost portion is transported obliquely downward between the recording/transporting unit 120 and the discharging unit 130 which are obliquely disposed relative to each other in the lower portion of the feeding unit 110. The roll paper is then discharged to a paper discharging tray (not shown) disposed in the leg portion 140 that is disposed in the lowermost portion of the ink-jet printer 100. The recording/transporting unit 120 and the paper discharging unit 130 are integrated as a main body, and the paper feeding unit 110 and the leg portion 140 are configured to be separable from the main body.

As shown in FIG. 1, the paper feeding unit 110 is disposed so as to protrude from the upper rear portion of the main body 120 and 130. Inside the paper feeding unit 110, as shown in FIG. 2, there is provided a roll paper holder (roll-like medium supporting device) 111 capable of having one roll paper R set therein. Further, as shown in FIGS. 1 and 2, a flip-up type roll paper cover 112 that can be open and closed is fitted to the front of the paper feeding unit 110.

As shown in FIG. 3, the roll paper holder 111 is provided with a fixed flange receiver (first holder member) 113, a movable flange receiver (second holder member) 114, and a guide rail (guide member) 115. The fixed flange receiver 113 is fixed to one of side walls of the paper feeding unit 110 so as to axially support the flange (flange member) 117 fitted to one end of the roll paper R in a rotatable manner. The movable flange receiver 114 is movably disposed in the other side wall of the paper feeding unit 110 so as to axially support the flange (flange member) 117 fitted to the other end of the roll paper R in a rotatable manner.

The guide rail 115 is disposed between the fixed flange receiver 113 and the movable flange receiver 114 so as to guide the sliding of the movable flange receiver 114. The roll paper R having both ends fitted to the flanges 117 is placed on the guide rail 115 along the guide rail 115. The flanges 117 at both sides are fitted to and supported by the fixed flange receiver 113 and the movable flange receiver 114. The movable flange receiver 114 can slide along the guide rail 115, and it is therefore possible to support different-sized roll papers R, as indicated by the dashed-dotted lines in the drawing.

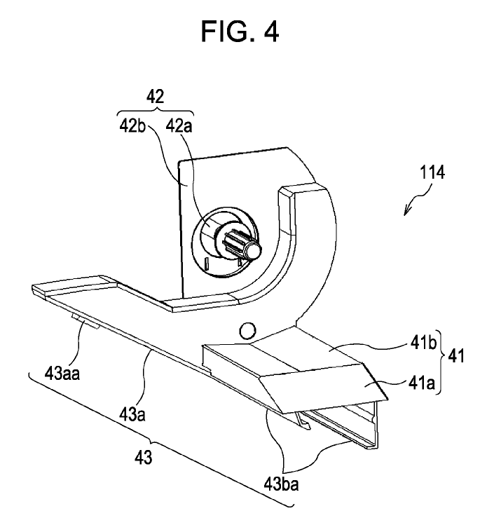

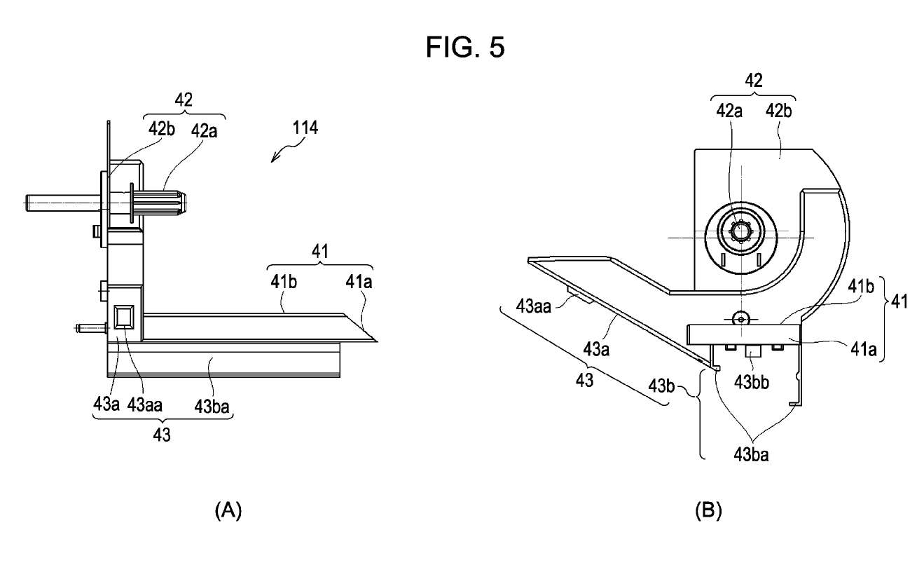

FIG. 4 is a detailed perspective view of the movable flange receiver 114; and FIGS. 5(A) and 5(B) are front and side views of the movable flange receiver 114. The fixed flange receiver 113 has the same construction as the movable flange receiver 114, except that the fixed flange receiver 113 is fixed to the side wall. Therefore, descriptions thereof will be omitted. The movable flange receiver 114 is provided with a flange guide portion 41, a support shaft portion 42, and a movable guide portion 43. The flange guide portion 41 is formed in a wedge shape, and extends in an axial direction of the roll paper placed on the guide rail 115 along the guide rail 115. The front end face of the flange guide portion 41 is formed in a taper shape (the face will be hereinafter referred to as a taper face 41a. The top face of the flange guide portion 41 is formed in a valley shape (the face will be hereinafter referred to as a valley face 41b). The taper face 41a is formed in an oblique face that slopes downward from the valley face 41b toward the front end of the flange guide portion 41, and the taper face 41 has a function of causing the flange portion 117 fitted to the roll paper to be guided over the taper face 41a. The valley face 41b is formed so as to extend along the axial direction of the roll paper, and the valley face 41b has a function of guiding the flange 117 along the taper face 41a to the support shaft portion 42.

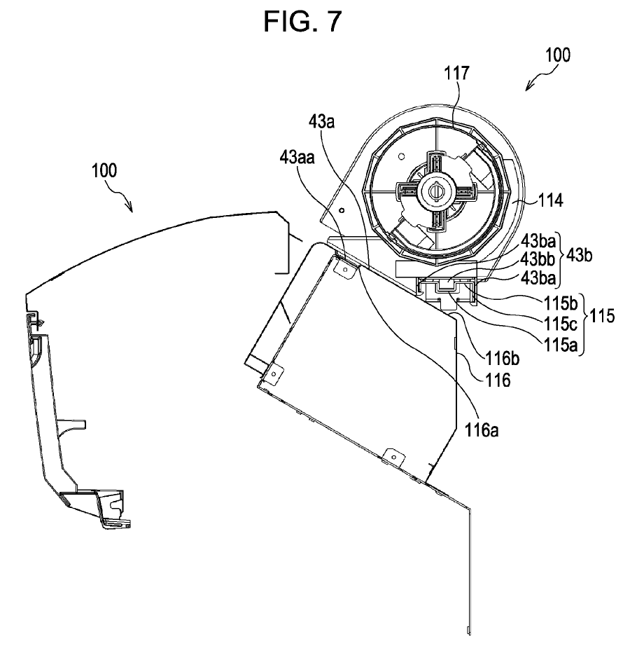

The support shaft portion 42 is disposed in the rear side of the flange guide portion 41, and a support plate 42b is erected so as to support the support shaft 42a. The support shaft 42a protrudes in the axial direction of the roll paper from the support plate 42b toward the flange guide portion 41, and the rotating shaft thereof is rotatably supported by the support plate 42b. The movable guide portion 43 is provided with a frame slide portion (movable guide portion) 43a making sliding contact with a frame member 116 (see FIG. 7) of the paper feeding unit 110 and a rail slide portion 43b making sliding contact with the guide rail 115. A guide protrusion (movable guide protrusion) 43aa is protrudingly formed on a bottom surface of the frame slide portion 43a. The guide protrusion 43aa is fitted to a guide groove (holder guide groove) 116a (see FIG. 7) that is formed in the frame member 116 so as to be parallel to the guide rail 115, and the guide protrusion 43aa guides the movement of the movable flange receiver 114. In the rail slide portion 43b, a rail holder 43ba and a guide protrusion 43bb are protrudingly formed on a bottom surface of the flange guide portion 41. The rail holder 43ba is fitted to the guide rail 115 (see FIG. 7) so that the guide rail 115 is inserted between both sides of the rail holder 43ba, and the rail holder 43ba guides the movement of the movable flange receiver 114. The guide protrusion 43bb is fitted to a guide groove 115a (see FIG. 7) formed in the guide rail 115, and the guide protrusion 43bb guides the movement of the movable flange receiver 114. The guide protrusions 43aa and 43bb formed in the frame slide portion 43a and the rail slide portion 43b may be formed as a guide groove. In this case, the guide grooves 116a and 115a are formed as a guide protrusion.

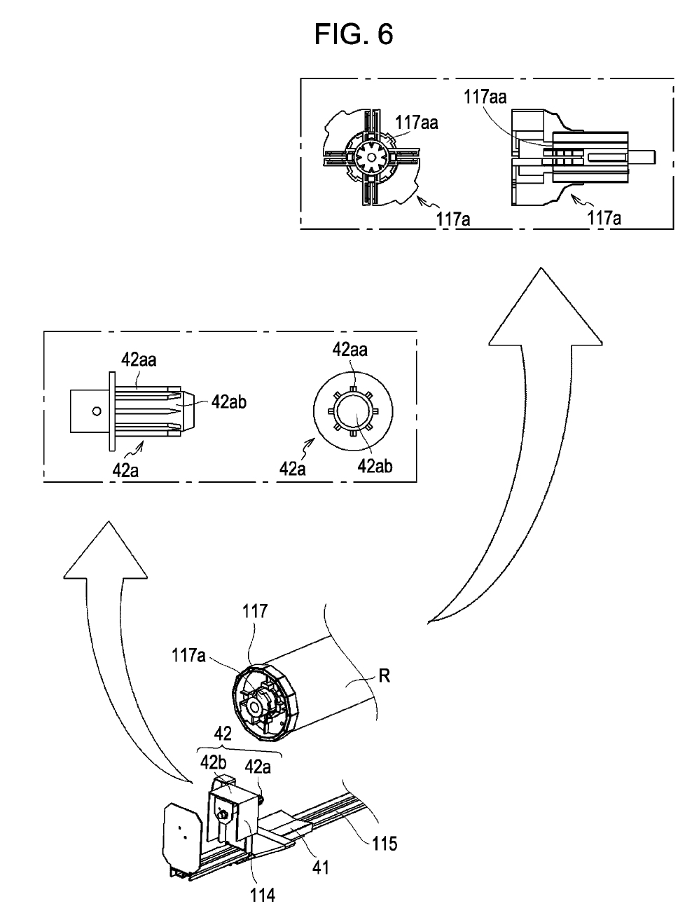

FIG. 6 is a detailed diagram showing the construction of the support shaft of the movable flange receiver 114 and a support bearing of the flange 117. In the support shaft 42a, a plurality of axially extending ribs (rotation regulating portion) 42aa (eight ribs are provided in this example) are integrally formed at regular angles on the circumferential portion of a main shaft body 42ab. The front end portions of the ribs 42aa and the main shaft body 42ab are formed in a taper shape. Meanwhile, a bore portion (rotation regulating portion) 117aa is formed in the support bearing 117a so that the main shaft body 42ab including the ribs 42aa of the support shaft 42a is inserted in the bore portion 117aa. According to such a configuration, since the front end portions of the ribs 42aa and the main shaft body 42ab are formed in a taper shape, the support shaft 42a of the movable flange receiver 114 can be inserted in the support bearing 117a of the flange 117 fitted to the roll paper R in an easy way. Additionally, since the rotation of the roll paper R is regulated by the support shaft 42a and the support bearing 117a after the roll paper R is set in the roll paper holder 111, it is possible to prevent unrolling of the roll paper R due to loosening.

FIG. 7 is a side sectional view of the movable flange receiver 114 of the paper feeding unit 110 and a peripheral portion thereof. The guide groove 116a is formed in an upper oblique face 116b of the frame member 116 of the paper feeding unit 110 so as to be parallel to the guide rail 115. The guide protrusion 43aa of the frame slide portion 43a is slidably fitted to the guide groove 116a. The guide groove 115a is formed in a top face 115b of the guide rail 115 in the longitudinal direction of the guide rail 115. The guide protrusion 43bb of the rail guide portion 43b is fitted to the guide groove 115a. The rail holder 43ba of the rail slide portion 43b is inserted and fitted to both side faces 115c of the guide rail 115. According to such a configuration, since the movable flange receiver 114 is guided by the guide protrusion 43aa and the guide protrusion 43bb, it is possible to smoothly guide the movement of the movable flange receiver 114 with high precision. Additionally, since the load of the roll paper set to the roll paper holder 111 is distributed to the frame slide portion 43a and the rail slide portion 43b, bending of the guide rail 115 can be suppressed and it is therefore possible to smoothly feed the roll paper with high precision.

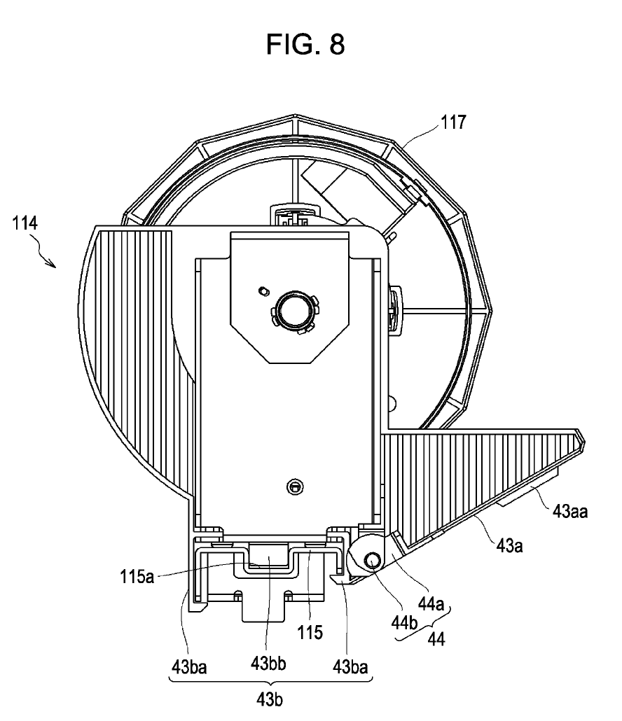

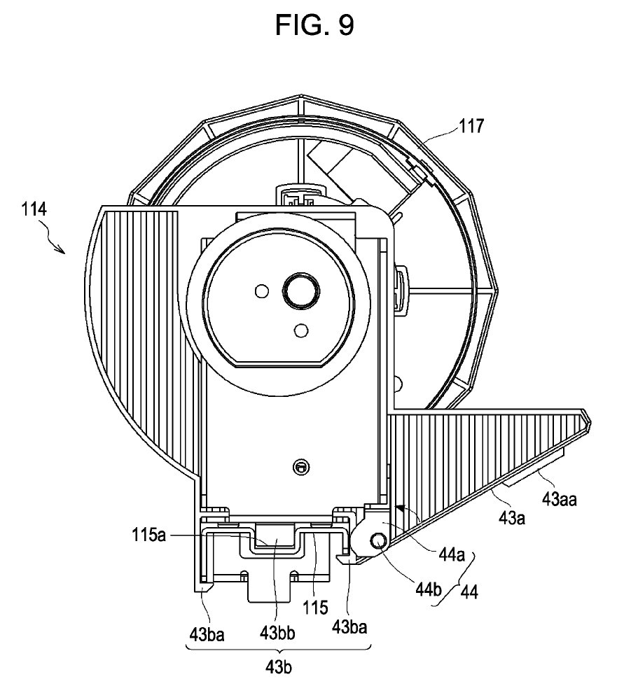

FIGS. 8 and 9 are side views of the movable flange receiver 114 and the peripheral portion thereof. In the lower portion of the movable flange receiver 114, a lock mechanism 44 is provided so as to lock the movable flange receiver 114. In the lock mechanism 44, a lock lever 44a is rotatably fitted to a lever shaft 44b disposed parallel to the guide rail 115. When the lock lever 44a is in the down position as shown in FIG. 8, the lock lever 44a is separated from the guide rail 115 and thus the movable flange receiver 114 is made movable. Meanwhile, when the lock lever 44a is erected by being turned in the arrow direction as shown in FIG. 9, the lock lever 44a makes contact with the guide rail 115 and thus presses the guide protrusion 43bb of the rail slide portion 43b toward the guide groove 115a of the guide rail 115. Accordingly, the movable flange receiver 114 can be locked at an arbitrary position. With such a configuration, it is possible to prevent oscillation of the roll paper supported therein.

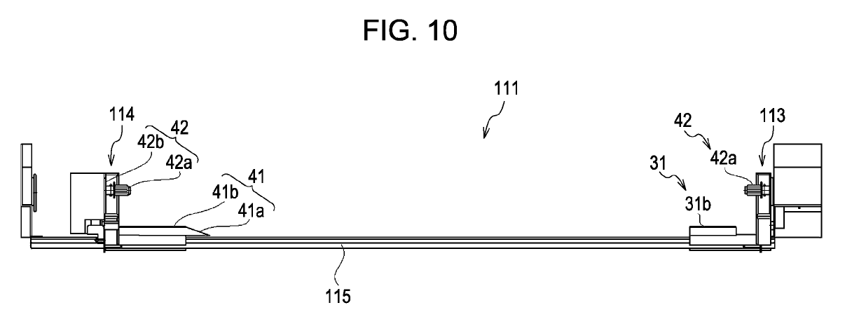

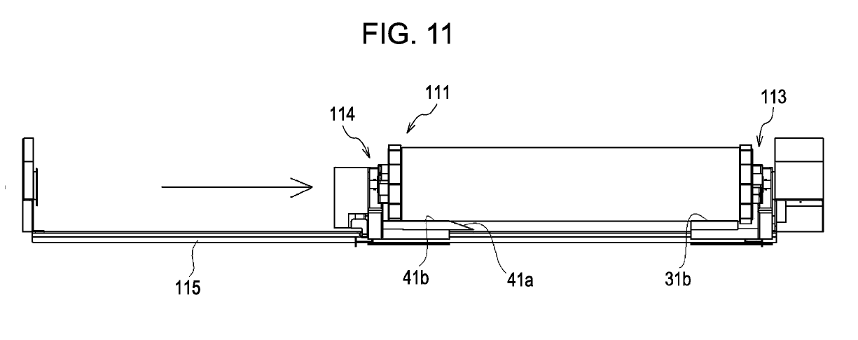

FIGS. 10 and 11 are diagrams for explaining an operation of setting the roll paper in the roll paper holder 111. As shown in FIG. 10, before setting the roll paper, the movable flange receiver 114 is moved to the far left side in the drawing. Then, a user fits the flanges 117 to both ends of the roll paper placed, for example, on the floor. With the roll paper held up with the user's hands, the right flange 117 is placed on the valley face 31b of the flange guide portion 31 in the fixed flange receiver 113, and the left flange 117 is placed on the guide rail 115. In this case, since the outer diameter of each of the flanges 117 is greater than the outer diameter of the roll paper, the flanges 117 make contact with the guide rail 115 and thus a gap is formed between the roll paper and the guide rail 115. Accordingly, the user can set the roll paper in the roll paper holder 111 with the roll paper held with both hands.

Then, the movable flange receiver 114 is moved toward the right side in the drawing. The left flange 117 fitted to the roll paper is guided over the taper face 41a of the flange guide portion 41 and slips onto the valley face 41b, thereby causing the support shaft 42a of the support shaft portion 42 to be inserted in the support bearing 117a. Then, the movable flange receiver 114 is further moved toward the right side as shown in FIG. 11. The support shaft 32a of the support shaft portion 32 in the fixed flange receiver 113 is inserted in the support bearing 117a of the right flange 117. In this way, the setting of the roll paper R is finished. According to the roll paper holder 111 of the present embodiment, the left and right flanges 117 can be fitted to the movable flange receiver 114 and the fixed flange receiver 113 in a simple manner.

As shown in FIGS. 1 and 2, the entire portion of the roll paper cover 112 is pivotably supported and is configured to be open or closed by the user raising or pressing down the lower portion of the roll paper cover 112. Accordingly, the user can open or close the roll paper cover 112 in a simple manner and it is therefore possible to reduce the replacing time of the roll paper R. Since the roll paper cover 112 is fitted so as to cover the roll paper holder 111, it is possible to prevent contamination of the roll paper R held in the roll paper holder 111 and to ensure the user's security.

As shown in FIG. 2, the recording/transporting unit 120 is provided with a carriage 122 having a recording head 121 mounted thereon, a flexible flat cable (hereinafter referred to as FFC) 123 for electrically connecting the recording head 121 to a control unit (not shown) for causing a recording operation to be performed, and an ink tube 124 for connecting the recording head 121 to an ink cartridge 10 filled with ink. The recording/transporting unit 120 is further provided with a paper feeding roller (not shown) and a driven roller (not shown) which are opposed to move toward and away from each other, a platen (not shown) disposed opposite the recording head 121 mounted on the carriage 122, and so forth. As shown in FIGS. 1 and 2, an upper cover 125 and a front cover 126 are fitted to the top and front faces of the recording/transporting unit 120 so as to cover the recording head 121, the carriage 122, and the like.

The recording head 121 is provided with a black ink recording head that ejects black ink and a plurality of color ink recording heads that eject each color of light yellow, yellow, light cyan, cyan, light magenta, and magenta. Further, the recording head 121 has a pressure generating chamber and nozzle openings communicating with the pressure generating chamber. The pressure generating chamber storing the ink therein is pressurized at a predetermined pressure, whereby size-controlled ink droplets are ejected from the nozzle openings to the roll paper. As shown in FIG. 2, the carriage 122 is suspended via a roller from a rail 127 provided in the main scanning direction and is coupled to a carriage belt 128. When the carriage belt 128 is operated by a carriage driving device (not shown), the carriage 122 cooperates with the movement of the carriage belt 128 and reciprocates while being guided by the rail 127.

As shown in FIG. 2, one end of the FFC 123 is connected to a connector of the control unit and the other end is connected to a connector of the recording head 121, so that recording signals are sent from the control unit to the recording head 121. The ink tube 124 is provided for each ink of different colors. One end of each ink tube 124 is connected to the ink cartridge 10 for corresponding color via an ink pressurizing/supplying device (not shown), and the other end of each ink tube 124 is connected to the recording head 121 for corresponding color. As shown in FIGS. 1 and 2, the lower portion of the front cover 126 is pivotably supported and is configured to be open or closed by the user pressing down or raising the upper portion of the front cover 126.

The paper feeding roller is formed as one lengthy roller, and both ends are axially supported by a side frame via a bearing. The paper feeding roller is driven with the driving force transmitted from a paper feeding motor via a pulley and a belt so as to rotate in a positive or negative direction. The driven roller is formed as a plurality of short rollers, and is axially supported by a plurality of driven-roller support members which are arranged above the paper feeding roller in parallel to the axial direction. The platen is formed in a rectangular flat plate shape slightly longer than the maximum recordable paper width, and is disposed close to the downstream side of the transportation path of the paper feeding roller.

As shown in FIGS. 1 and 2, the paper discharging unit 130 is provided with a paper discharging guide 131 forming a part of the path through which the roll paper is transported in the sub-scanning direction and a paper discharging roller (not shown) for transporting the roll paper in the sub-scanning direction. As shown in FIGS. 1 and 2, the leg portion 140 is provided with two support pillars 142 having moving casters 141 and a reinforcing bar 143 stretched between the support pillars 142. The paper feeding unit 110 and the body 120 and 130 are placed on the support pillars 142 and fixed with screws.

As shown in FIGS. 1 and 2, a holder body 151 for receiving and holding the ink cartridge 10 for each color and an ink cartridge holder 150 having a cover 152 for covering the front of the holder body 151 are disposed on the left side of the body 120 and 130 as seen from the front side thereof. As shown in FIGS. 1 and 2, an operation panel 160 for allowing the user to perform a recording control and the like is disposed in the upper portion on the right side of the body 120 and 130 as seen from the front side thereof. A liquid crystal screen and various buttons, which are electrically connected to a control unit (not shown), are disposed on the operation panel 160 and the user is allowed to push the buttons while looking at the screen for confirmation.

As described above, the roll paper holder 111 of the present embodiment is provided with the flanges 117 that are fitted to both ends of the roll paper, the fixed flange receiver 113 that is fixed to the printer main body so as to support one of the flanges 117, and the movable flange receiver 114 that is disposed in the printer main body to be movable in the axial direction of the roll paper so as to support the other flange 117. Accordingly, it is possible to eliminate necessity of a conventional lengthy roll shaft and thus to set the roll paper in a simple manner. The roll paper holder 111 is further provided with the guide rail 115 that guides the movement of the movable flange receiver 114. Thus, it is possible to handle roll papers with different widths in a simple manner. In addition, the movable flange receiver 114 is provided with the frame slide portion 43a that makes sliding contact with the printer main body and guides the movement of the movable flange receiver 114. Therefore, the movable flange receiver 114 can be supported in a distributed manner that the movable flange receiver 114 is supported by the frame member 116 being in contact with the frame slide portion 43a as well as by the guide rail 115 being in contact with the rail slide portion 43b. Accordingly, the roll paper can be set with high precision.

The roll paper holder 111 of the present embodiment can be applied to a recording apparatus such as facsimiles or copying machines as long as a roll paper is usable in the recording apparatus.

1. A roll-like medium supporting device which supports both ends of a roll-like medium, the device comprising:
flange members that are fitted to both ends of the roll-like medium;
a first holder member that is fixed to a main body of the device so as to support one of the flange members; and
a second holder member that is disposed in the main body of the device to be movable in the axial direction of the roll-like medium so as to support the other flange member.

2. The roll-like medium supporting device according to claim 1, wherein the device further comprises a guide member that guides the movement of the second holder member.

3. The roll-like medium supporting device according to claim 1, wherein the second holder member is provided with a flange guide portion that guides the other flange member when the other flange member fitted to the roll-like medium is supported by the second holder member.

4. The roll-like medium supporting device according to claim 2, wherein the second holder member is provided with a flange guide portion that guides the other flange member when the other flange member fitted to the roll-like medium is supported by the second holder member.

5. The roll-like medium supporting device according to claim 3, wherein the flange guide portion is provided with a taper face for causing the flange member to slip thereon.

6. The roll-like medium supporting device according to claim 4, wherein the flange guide portion is provided with a taper face for causing the flange member to slip thereon.

7. The roll-like medium supporting device according to claim 1, wherein the outer diameter of each of the flange members is greater than the outer diameter of the roll-like medium.

8. The roll-like medium supporting device according to claim 1, wherein the flange members and the second holder member are provided with a rotation regulating portion that regulates the rotation of the roll-like medium when the roll-like medium is supported by the device.

9. A recording apparatus which records data on a roll-like recording medium while transporting the roll-like recording medium, the apparatus comprising the roll-like medium supporting device according to claim 1.

10. A roll-like medium supporting device which supports both ends of a roll-like medium, the device comprising:
flange members that are fitted to both ends of the roll-like medium;
a first holder member that is fixed to a main body of the device so as to support one of the flange members;
a second holder member that is disposed in the main body of the device to be movable in the axial direction of the roll-like medium so as to support the other flange member; and
a guide member that guides the movement of the second holder member,
wherein the second holder member is provided with a movable guide portion that makes sliding contact with the main body of the device and guides the movement of the second holder member.

11. The roll-like medium supporting device according to claim 10, wherein the movable guide portion includes a movable guide protrusion or a movable guide groove, which is formed to correspond to a holder guide groove or a holder guide protrusion formed in the main body of the device.

12. The roll-like medium supporting device according to claim 10, wherein the second holder member is positioned at a predetermined position corresponding to the width of the roll-like medium.

13. The roll-like medium supporting device according to claim 10, wherein the second holder member has a lock mechanism that locks the second holder member at the guide member.

14. A recording apparatus which records data on a roll-like recording medium while transporting the roll-like recording medium, the apparatus comprising the roll-like medium supporting device according to claim 10.
